(19) United States
(12) Patent Application Publication
(10) Pub. No.: US 2020/0136534 A1
(43) Pub. Date: Apr. 30, 2020

(54) RAPID HILL HOLD AUTO-BALANCE APPARATUS AND METHOD FOR VEHICLES PROPELLED BY MAGNETIC SYNCHRONOUS MOTORS

(71) Applicants: Yujiang Wu, La Verne, CA (US); YANG SUN, San Dimas, CA (US); Justin William V. Jones, Irvine, CA (US); MAtthew M. Allen, Fullerton, CA (US)

(72) Inventors: Yujiang Wu, La Verne, CA (US); YANG SUN, San Dimas, CA (US); Justin William V. Jones, Irvine, CA (US); MAtthew M. Allen, Fullerton, CA (US)

(21) Appl. No.: 16/583,296

(22) Filed: Sep. 26, 2019

Related U.S. Application Data
(60) Provisional application No. 62/752,038, filed on Oct. 29, 2018.

(51) Int. Cl. H02P 3/02; B60L 50/50; B60W 30/18

(52) U.S. Cl. CPC H02P 3/025; B60W 30/18118; B60L 50/50

(57) ABSTRACT

An auto-balance hill-hold apparatus and method for arresting unintentional roll after coming to a stop on a hill or slope in vehicles powered by magnetic synchronous motors by automatically determining and rapidly applying the appropriate balancing counter-torque required to negate torque caused by the acceleration of gravity, and subsequently communicating the magnitude of the determined counter-torque to a speed controller so that it may seamlessly transition to an alternative and more efficient method of generating the equivalent balancing counter-torque and provide a smoother transition to operation mode.

### CROSS-REFERENCE TO RELATED APPLICATIONS

This U.S. Non-Provisional Utility Patent Application claims the priority date of U.S. Provisional Application No. 62/752,038, titled: “PSEUDO FEED-FORWARD ACCELERATION TORQUE COMMAND METHOD FOR ROBUST ELECTRIC VEHICLE HILL-CONTROL RESPONSE,” filed Oct. 29, 2018 in the United States Patent and Trademark Office, the disclosure of which is hereby incorporated by reference in its entirety.

### FIELD OF THE PRESENT DISCLOSURE

This disclosure relates generally to an improved apparatus and method of rapidly arresting an electrically propelled vehicle after it comes to a stop on a hill or slope, and more specifically to an innovative apparatus and method of automatically preventing a vehicle from rolling after coming to a stop on a hill or slope by rapidly calculating and applying the appropriate counter-torque required to balance the torque created by the acceleration due to gravity acting on the mass of the vehicle and subsequently using the minimum necessary power to maintain such torque equilibrium.

### BACKGROUND OF THE RELATED ART

Traditionally, when a driver brings an automobile to a complete stop on a hill or slope, the driver must continuously press the brake to avoid subsequent rolling caused by gravity's effect on the vehicle. If the hill or slope is angled upward from the driver's perspective this can present a challenge when the driver subsequently wishes to accelerate the vehicle in the forward direction because the driver must typically release the brake and then depress or activate the accelerator in a short enough period of time to avoid allowing the vehicle to roll backward due to gravity.

Executing this maneuver in a timely manner is especially important when other vehicles or pedestrians are located closely behind the driver's vehicle which could be struck if the vehicle is allowed to roll backward. A similar challenge also exists in the opposite direction when a driver is attempting to accelerate in reverse up a hill or slope and must avoid rolling forward between the time when the driver releases the brake and the time when the driver depresses the accelerator sufficiently to initiate backward motion.

In legacy vehicles that are powered by an internal combustion engine and a standard transmission, the issue of hill-roll is particularly problematic because the driver must both time the transition from depressing the brake to sufficiently depressing the accelerator and successfully modulate the rate of engagement between the engine to the transmission via the clutch. If the driver's timing of either of these maneuvers is lacking the vehicle could roll backward unintentionally and potentially cause an accident or injury.

In legacy vehicles that are powered by internal combustion engines with automatic transmissions, this issue can be partially mitigated by setting the transmission idle with slight pressure on the drive train in the direction of the selected gear thereby reducing the vehicle's tendency to roll in the opposing direction of the selected gear.

Similarly, many electrically powered vehicles have attempted to mitigate the hill-roll problem by applying some minimum amount of current to the motor to produce torque to counter act the vehicle's tendency to roll when the brake is released and the accelerator is not sufficiently activated. However, determining when to apply such current to the motor, how much current to apply, and how to collect the data to make such determination has proved to be a challenging problem that has led to a variety of innovative solutions with various advantages and disadvantages.

Some known legacy solutions include the method set forth in U.S. Pat. No. 6,825,624 which discloses a system of maintaining an electrically powered vehicle in a stopped position on an incline by manipulating switching patterns and regulating the duty cycle with pulse width modulator technology. This system, however, does not determine the torque necessary to prevent the vehicle from rolling so the transition from hill-hold mode to normal drive mode is not as smooth as it could be if such information was both calculated and communicated between modes.

Other legacy systems are considerably more complex, like the system described in United States published application 2007/0191181 which comprises a series of sensors including a vehicle stabilization sensor that is capable of preemptively determining the grade of a hill or slope on which the vehicle is travelling and calculating the likely torque required to prevent hill roll on that slope, or United States published application 20150197240 which discloses a hill-hold system for hybrid electric and electric vehicles using multiple additional hardware components including clutches integrated with the motor and/or engine. While such systems may be capable of performing their designed purpose well, the additional hardware and complex sensors generally increase the cost manufacturing and may also present a reliability issues due to the complexity.

Still other legacy solution solutions rely on feedback controllers based on the motor position indicated by the resolver or encoder. While these solutions have the advantage that they do not require additional hardware or expensive sensors, they typically do require some small amount of time effective resolve the hill-hold issue because, like all PI or PID controllers, they operate through a iterative feedback loop including the steps of: 1) retrieving position data; 2) calculating action appropriate current to achieve desired result; 3) commanding the appropriate current to achieve desired result; 4) retrieving new position data; 5) calculating whether previous action achieve desire result response or not; and 6) calculating new appropriate current to achieve desired result. While this loop of sensing and responding via a controller happens fairly quickly, it is possible to resolve a hill-roll issue more rapidly such as through the use of an auto-balance system.

An auto-balance system works by taking advantage of the fact that as a permanent magnet motor rolls backwards, a predetermined current vector initialized at an angle of zero with respect to the current's synchronous frame will result in increasing torque as the rotor continues to rotate. If the initial current is properly chosen for the motor in question, the weight of the vehicle and the range of likely slope grades, the increasing torque will increase until it balances with the vehicles tendency to roll due to gravity. The advantage of this process is that it does not require additional special sensors and it arrests the unwanted vehicle motion much more rapidly than systems that use traditional PI or PID controllers because multiple iterations are not required.

However, legacy auto-balance system have disadvantages as well. The main such disadvantages are that the predetermined current used in an auto-balance system is relatively high so that it can function over a full range of likely grade slopes which means that, on average it is consuming much more power than necessary to hold a vehicle still on an average grade slope. This can have a detrimental effect of both the motor longevity and overall power efficiency. Also, legacy auto-balance systems do not calculate and communicate the torque that is ultimately required to arrest the unwanted vehicle motion to the speed controller so, similar to other legacy solutions, the transition from hill-hold mode to normal drive mode is not as smooth as it could be if such information was both calculated and communicated between modes.

The present disclosure distinguishes over the related art providing heretofore unknown advantages as described in the following summary.

### BRIEF SUMMARY OF THE INVENTION

The present disclosure describes an improved apparatus and method of automatically preventing a permanent magnetic synchronous motor powered vehicle from unintentionally rolling after being brought to a stop on a hill or slope by rapidly determining and applying the appropriate opposing torque required to counter balance the torque force caused by the acceleration of gravity acting on the mass of the vehicle. Subsequently, the innovative hill-hold apparatus and method communicates the magnitude of the counter balancing torque to a speed controller so that the speed controller may both seamlessly transition to generating the equivalent counter balancing torque in a more energy efficient manner and provide a smoother transition back to drive mode, when instructed.

In a preferred embodiment, the apparatus and method initiates when the resolver, encoder, or equivalent detects that the magnetic synchronous motor's rotor is rotating in the opposite direction of the gear selection such as when backward roll is detected while a forward gear is selected or when forward roll is detected when the vehicle is in a reverse oriented gear. This situation typically arises when a vehicle is brought to a stop on a hill or slope and neither the brake nor the accelerator is sufficiently activated to overcome the torque force caused by the acceleration of gravity acting on the mass of the vehicle causing the vehicle to begin to roll unintentionally.

In another embodiment, the apparatus and method may be initiated when unintentional roll is detected in either direction regardless of the gear selection. In such embodiments, the initiating trigger may be the detection of uncommanded roll in any direction after the vehicle has been brought to a full stop for some predetermined period of time.

Regardless of the triggering event, immediately after initiation is triggered the apparatus and method records the rotor's angular flux position and applies a static current of predetermined magnitude (Iₛ) in the vector direction of the rotor flux's at initiation. Subsequently, as the vehicle continues to roll the angle between the current vector and the rotor flux position (θ) increases which results in the generation of a counter balancing torque of increasing magnitude. When the generated counter balancing torque equals the magnitude of the gravity induced torque, the net torque of the motor reaches zero and the vehicle's motion is successfully arrested.

If the generated counter balancing torque exceeds the torque due to gravity the vehicle will roll back in the opposing direction decreasing the angle between the current vector and the rotor flux position (θ) which will proportionally decrease the counter balancing torque. By allowing the rotation of the vehicles rotor to automatically determine the appropriate counter balancing torque without the use of a PI or PID controller an equilibrium between the torque due to gravity and the generated counter balancing torque is reached very rapidly, much faster than legacy methods involving speed controllers and the associated back/forward slip in such auto-balance systems is negligible.

Once the unintentional vehicle roll is arrested the presently disclosed apparatus and method communicates the precise torque found necessary to maintain torque equilibrium to a speed controller so that the torque can be generated in a more power efficient manner by varying the combination of i_{d} and i_{q} to reach the maximum torque per ampere point or MTPA point. This is a significant advantage over legacy auto-balance systems because the magnitude of the initial predetermined current (Iₛ) must be a relatively high value so that it is capable generating the magnitude of the torque necessary to arrest unintentional roll through the entire range of conditions that may arise during normal operation of the vehicle taking into considerations such as the weight of the vehicle as likely loaded during typical use, the strength and efficiency of the magnetic synchronous motor, and the range of slope and hill grades that the vehicle will likely encounter during normal operation.

However, once the magnitude of the precise torque necessary to maintain torque equilibrium is known, a speed controller can replicate the necessary torque to maintain torque equilibrium at the MTPA point with lower current in a different current vector and thus conserve power. This is of critical importance for a number of reasons including avoiding damage or reduction of lifespan of the major components of the motor drive due to high current for extended durations, as well as, increasing power efficiency of the innovative hill-hold apparatus and method, which is always of paramount importance in the field of electric powered vehicles.

In the unlikely event that θ becomes greater than 90 degrees and torque equilibrium has not been achieved, control can be passed directly to the speed controller to arrest the unintentional roll; however, with a carefully chosen Iₛ value such occurrences should be rare if not nonexistent.

When torque equilibrium is reached, the presently disclosed apparatus and method calculates the precise torque value necessary to maintain equilibrium by performing a simple calculation. The torque output of a permanent magnetic synchronous motor can be calculated by the following equation:

Tₑₘ=3/2p(ψ_{f}i_{sq}+(L_{d}−L_{q})i_{sd}i_{sq},
where p is the pole pairs, ψ_{f} is the flux linkage, i_{sd} and i_{sq} are the d- and q-axis components of the stator current, and L_{d} and L_{q} are the d- and q-axis inductances.

By substituting θ which is the angle between ψ_{f} (the flux linkage in the synchronous frame i_{sd}) and Iₛ (the predetermined current applied in the vector direction of the rotors flux at initiation) the torque equation can be rewritten as:

Tₑₘ=3/2Iₛ sin θ(ψ_{f}+(L_{d}−L_{q})Iₛ cos θ.

With knowledge of the predetermined magnitude of Iₛ and the angle θ, as reported by the resolver, when the unintentional roll is arrested the precise counterbalancing torque value can be determined and communicated to the speed controller which can subsequently generate the equivalent torque value by commanding a lower current in a different vector corresponding to the MTPA point, thereby increasing the power efficiency compared to legacy auto-balance systems.

Further as previously stated, by communicating the precise torque found necessary to maintain equilibrium to the speed controller and instructing the speed controller to maintain the necessary counter balancing torque while maintaining hold mode, the speed controller is also enabled to seamlessly transfer into drive mode with no perceptible interruption of power as is present in legacy auto-balance style systems.

This disclosure teaches certain benefits in construction and use which give rise to the objectives described below:

A primary objective inherent in the above described apparatus and method is to provide advantages not taught by the prior art;

Another objective is to provide an apparatus and method of arresting unintentional roll of a vehicle propelled by a permanent magnetic synchronous motor after it comes to a stop on a hill or slope and the driver has not sufficiently disengaged the accelerator or break to avoid rolling, thereby providing the driver greater ease on operation;

A further objective is to provide an auto-balance style apparatus and method of arresting unintentional roll of a vehicle propelled by a permanent magnetic synchronous motor after it comes to a stop on a hill or slope and the driver has not sufficiently disengaged the accelerator or break to avoid rolling, that uses lower current than legacy auto-balance style systems, thereby avoiding damage or reduction of lifespan of the major components of the motor drive due to high current for extended durations;

A still further objective is to provide an auto-balance style apparatus and method of arresting unintentional roll of a vehicle propelled by a permanent magnetic synchronous motor after it comes to a stop on a hill or slope and the driver has not sufficiently disengaged the accelerator or break to avoid rolling, that uses lower current than legacy auto-balance style systems, thereby increasing power efficiency relative to such legacy systems.

A yet still further objective is to provide an apparatus and method of arresting unintentional roll of a vehicle propelled by a permanent magnetic synchronous motor after it comes to a stop on a hill or slope and the driver has not sufficiently disengaged the accelerator or break to avoid rolling, that transfers hold control to a speed controller and therefore is capable of transitioning from hold mode to into drive mode more smoothly.

Other features and advantages of the present invention will become apparent from the following more detailed descriptions, taken in conjunction with the accompanying drawings, which illustrate, by way of example, the principles and features of the presently described apparatus.

### BRIEF DESCRIPTION OF THE SEVERAL VIEWS OF THE DRAWINGS

The accompanying drawings illustrate various exemplary implementations and are part of the specification. The illustrated implementations are proffered for purposes of example not for purposes of limitation. Illustrated elements will be designated by numbers. Once designated, an element will be identified by the identical number throughout. Illustrated in the accompanying drawing(s) is at least one of the best mode embodiments of the present disclosure. In such drawing(s):

FIG. 1 is a simple diagram depicting the various current amplitudes that can achieve a given torque and the various torques that can be achieved by and the various torques achieved by the predetermined amplitude Iₛ as a function of (θ).

FIG. 2 is a simple diagram depicting the various inputs required for the speed controller to achieve the equivalent counter balancing torque with lower current.

FIG. 3 is a high level diagram depicting the basic component of presently disclosed apparatus integrated with the power train of an electrically propelled vehicle.

FIG. 4 is a flowchart depicting the various steps and logic decisions required to perform an embodiment of the presently disclosed method.

### DETAILED DESCRIPTION OF THE EXEMPLARY EMBODIMENT

The above described drawing figures illustrate an exemplary embodiment of the presently disclosed apparatus and its many features in at least one of its preferred, best mode embodiments, which is further defined in detail in the following description. Those having ordinary skill in the art may be able to make alterations and modifications to what is described herein without departing from its spirit and scope of the disclosure. Therefore, it must be understood that what is illustrated is set forth only for the purposes of example and that it should not be taken as a limitation in the scope of the present apparatus or its many features.

Described now in detail is an innovative apparatus and method of automatically preventing a vehicle from rolling after coming to a stop on a hill or slope by rapidly calculating and applying the appropriate counter-torque required to balance the torque created by the acceleration due to gravity acting on the mass of the vehicle and subsequently using the minimum necessary power to maintain such torque equilibrium.

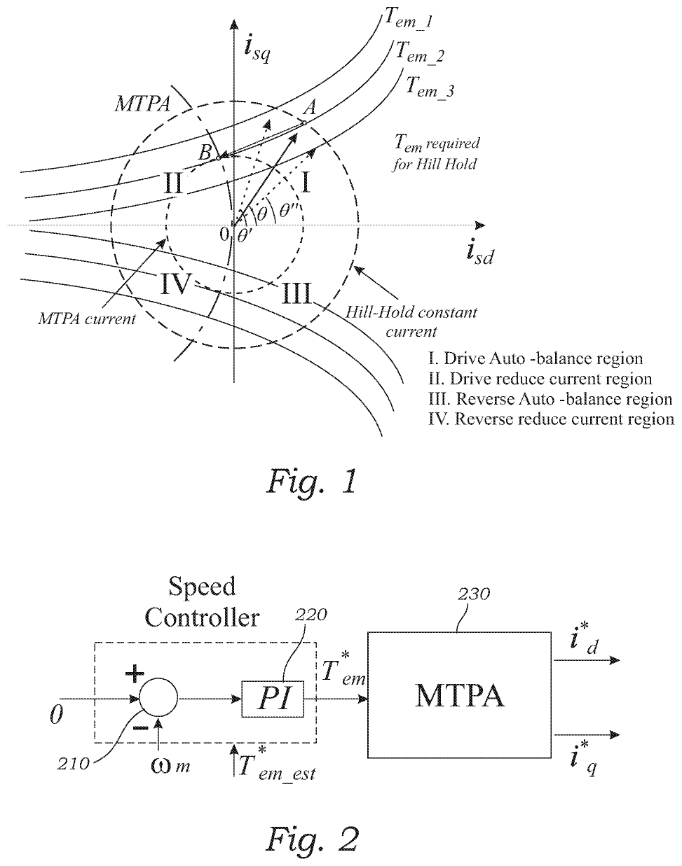

FIG. 1 is an illustration depicting the various torques that can be achieved by the predetermined current Iₛ as the angle between the current vector and the rotor flux position (θ) increases or decreases. In the illustration, the predetermined current Iₛ at the angle θ achieves the torque is T_{em_2}. If θ increases to θ′ the resulting torque increases to T_{em_1}, whereas if the torque decreases to θ″ then the resulting torque decreases to T_{em_3}. It is through this immediate response that the auto-balancing system can rapidly provide a counter torque to negate the torque caused by gravity and reach and equilibrium. FIG. 1 also show that the torque of T_{em_2} can also be achieved by commanding a lower current in a different vector such as point B which exists along the MTPA curve.

FIG. 2 illustrates the components necessary to maintain the equilibrium torque determined by the auto-balance system while using less current. An MTPA speed controller can regulate the speed to zero given the torque value calculated by the following equation:

Tₑₘ=3/2Iₛ sin θ(ψ_{f}+(L_{d}−L_{q})Iₛ cos θ.

The motor's resolver, encoder, or equivalent provides the value for θ and Iₛ is a predetermined constant.

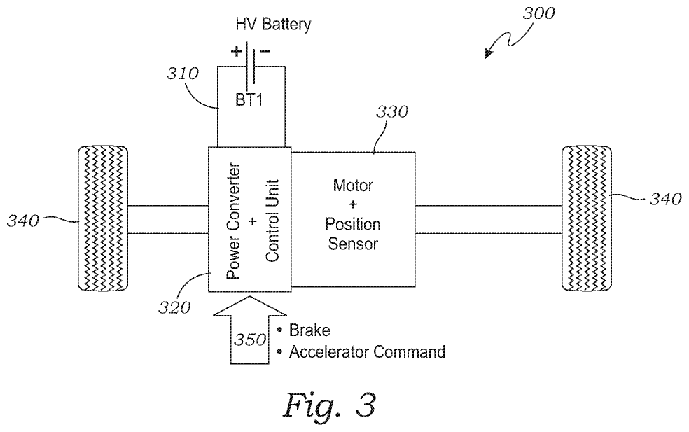

FIG. 3 illustrates the high level components of the apparatus. Essentially, the presently disclosed apparatus 300 requires a control unit 320 and a speed controller 320 in communication with the motor's position sensor 330 and brake and accelerator signals 350. When the brake and accelerator signals are indicating that there are insufficient brake or accelerator commands 350 to hold the vehicle still, the controller 320 initially commands a predetermined current Iₛ and when the motor's position sensor 330 confirms that equilibrium has been reached, the controller 320 calculates the required torque given the rotation θ as confirmed by the motor's position sensor 330 and commands the speed controller 320 to achieve the equivalent torque at the lowest possible current.

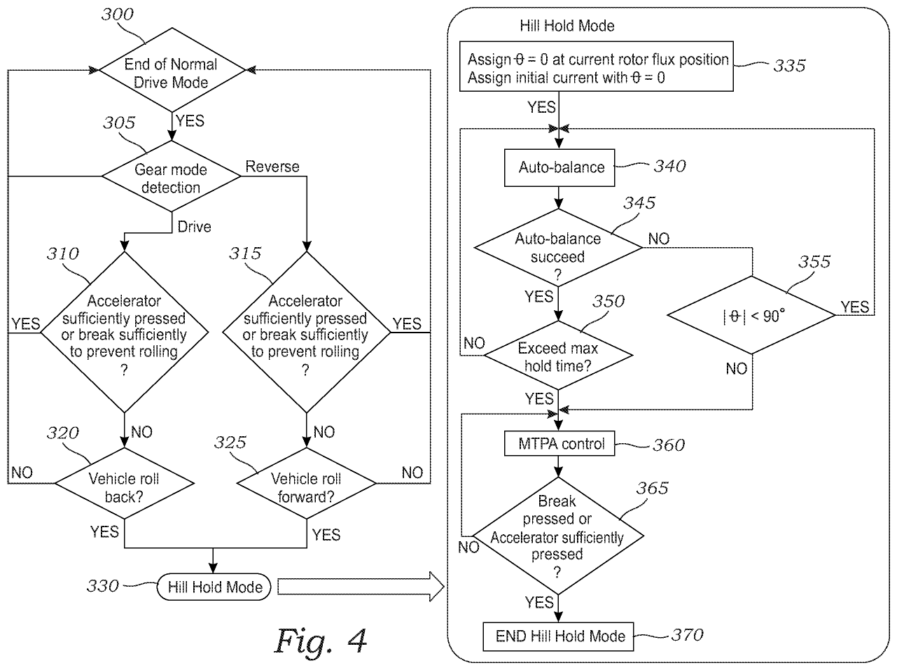

FIG. 4 is a flowchart depicting the various steps and logic decisions required to perform an embodiment of the presently disclosed method starting with ending of normal drive mode 300 such as when the driver in giving the vehicle instructions to move intentionally. In the illustrated embodiment, the method makes a determination whether a forward oriented gear or a reverse oriented gear is selected 305, whether the brake or accelerator is sufficiently activated to prevent vehicle roll 310 or 315, and whether the vehicle is, in fact, rolling in an opposing direction of the selected gear 320 and 325. If the answer is affirmative to the last questions presented in 320 and 325 hill-hold mode will initiate.

Hill hold mode begins by immediately assigning θ to 0 at the rotor flux position at the moment of initiation and commanding a predetermined initial current at the vector θ=0 335. The vehicle is then allowed to roll and generate proportionate counter balancing torque 340. If equilibrium is successfully reached and the vehicle is no longer rolling 345 then after a predetermined amount of time control is passed to the MTPA speed controller 360. If the auto-balance has not successfully achieved zero roll velocity 345 then the absolute value of θ is examined to determine if it is greater than 90 degrees 355. If it is greater than 90 degrees then control is passed to the MTPA speed controller 360, if it is not greater than 90 degrees then the auto-balance step is allowed to continue 340.

The MTPA speed controller 360 commands the equivalent torque determined sufficient to counter balance the torque at the maximum torque per ampere point (MTPA point) and continues until the accelerator or brake is activated by the driver 365 causing hill hold mode to end 370.

The enablements described in detail above are considered novel over the prior art of record and are considered critical to the operation of at least one aspect of the apparatus and its method of use, and to the achievement of the above-described objectives. The words used in this specification to describe the instant embodiments are to be understood not only in the sense of their commonly defined meanings, but to include by special definition in this specification: structure, material, or acts beyond the scope of the commonly defined meanings. Thus, if an element can be understood in the context of this specification as including more than one meaning, then its use must be understood as being generic to all possible meanings supported by the specification and by the word(s) describing the element.

The definitions of the words or drawing elements described herein are meant to include not only the combination of elements which are literally set forth, but all equivalent structures, materials or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, substitutions, now or later known to one with ordinary skill in the art, are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. An improved method of rapidly preventing post stoppage wheel roll in electrically propelled vehicles, said method comprising the steps of:
receiving notification from position sensors that the rotor of the electric motor has began rotating in the opposite direction of the selected gear;
recording the initial position of the rotor;
applying an initial current of a pre-determined magnitude in the vector direction of the initial position of the rotor to the electric motor;
determining the angle of rotation of the rotor rotation from when said initial current was applied to the motor until rotor ceases rotating or phase angle equals MTPA angle to determine modified current;
engaging speed controller to produce torque equal to torque created by initial current of a pre-determined magnitude in the vector direction of the initial position of the rotor to the electric motor.

10. An apparatus for rapidly preventing post stoppage wheel roll in electrically propelled vehicles, said apparatus comprising:
a position sensor, integrated with an electrical motor such that it can determine the position of the rotor;
activation sensors on the electric vehicles brake and accelerator that can determine when the brake and accelerator is activated;
a (traditional) speed control; and
power source;
a controllable power so;
